(19) United States
(12) Patent Application Publication
(10) Pub. No.: US 2015/0239744 A1
(43) Pub. Date: Aug. 27, 2015

(54) ARRANGEMENT AND PROCESS FOR INTEGRATED FLUE GAS TREATMENT AND SODA ASH PRODUCTION

(71) Applicant: ALSTOM Technology Ltd, Baden (CH)

(72) Inventors: Olaf STALLMANN, Essenheim (DE); Christoph WEINGÄRTNER, Gau-Algesheim (DE); Michael Charles BALFE, Mainz (DE)

(21) Appl. No.: 14/630,037

(22) Filed: Feb. 24, 2015

(30) Foreign Application Priority Data
Feb. 25, 2014 (EP) 14156466.6

(51) Int. Cl. C01D 7/12

(52) U.S. Cl. CPC C01D 7/126

(57) ABSTRACT

The arrangement of a flue gas treatment system by carbonation-calcination loop and soda ash production system by Solvay process has CaO and heat for use in the soda ash production system extracted from the flue gas treatment system.

### CROSS-REFERENCE TO RELATED APPLICATIONS

This application claims priority to European Application 14156466.6 filed Feb. 25, 2014, the contents of which are hereby incorporated in its entirety.

### TECHNICAL FIELD

The present invention relates to an arrangement and process for integrated flue gas treatment and soda ash production.

### BACKGROUND

Soda ash (sodium carbonate Na₂CO₃) is used in many industrial processes; there is therefore a need to produce large amounts of soda ash. The most used process for soda ash production is currently the so called Solvay process. The Solvay process works according to the global reaction

2NaCl+CaCO₃→Na₂CO₃+CaCl₂.

Therefore in order to produce soda ash, NaCl, limestone CaCO₃ (to produce CaO according to the dissociation reaction CaCO₃→CaO+CO₂; CaO is then used for soda ash production) and heat must be supplied for reaction. During the soda ash production also ammonia NH₃ is used as one of the reagents, but ammonia is regenerated at the end of the Solvay process, therefore supply of fresh ammonia is not needed or is needed only to a limited extent.

Flue gas treatment systems are often needed downstream of a combustion process such as a boiler of a large power plant or a furnace of an industrial installation in order to reduce emissions within limits imposed by law. Usually carbon dioxide CO₂ emissions must be controlled and flue gas treatment systems are often provided to capture carbon dioxide CO₂ contained in flue gas from a combustion process.

A number of different carbon dioxide capture systems exist. One of such carbon dioxide capture system is the so called carbonation-calcination loop. According to this system, flue gas is supplied into a carbonator wherein CO₂ contained in the flue gas combines with a metal oxide, usually CaO, to form a metal carbonate compound, such as CaCO₃. This process occurs at about 650° C. The metal carbonate compound such as CaCO₃ is forwarded into a calciner wherein the metal carbonate compound CaCO₃ is decomposed by heat at a temperature between 900-1050° C. into metal oxide such as CaO and carbon dioxide CO₂. The carbon dioxide can thus be removed and forwarded to further treatments and/or storage. CaO is recirculated into the carbonator.

The inventors have found a way to integrate the soda ash production by Solvay process and the flue gas treatment system.

### SUMMARY

An aspect of the disclosure includes providing an arrangement and process for integrated flue gas treatment and soda ash production that permit an increased global efficiency.

These and further aspects are attained by providing an arrangement and a process in accordance with the accompanying claims.

Advantageously, the lime CaO and heat that are needed at the soda ash production process are extracted from the flue gas treatment system. This allows the use of a byproduct from the flue gas treatment system as a reagent or heat source for the soda ash production process, such that fresh lime CaO or combustion of fuel specifically for use at the soda ash production process are not needed or are reduced.

### BRIEF DESCRIPTION OF THE DRAWINGS

Further characteristics and advantages will be more apparent from the description of a preferred but non-exclusive embodiment of the arrangement and process, illustrated by way of non-limiting example in the accompanying drawings, in which:

FIG. 1 shows an example of an arrangement of the invention.

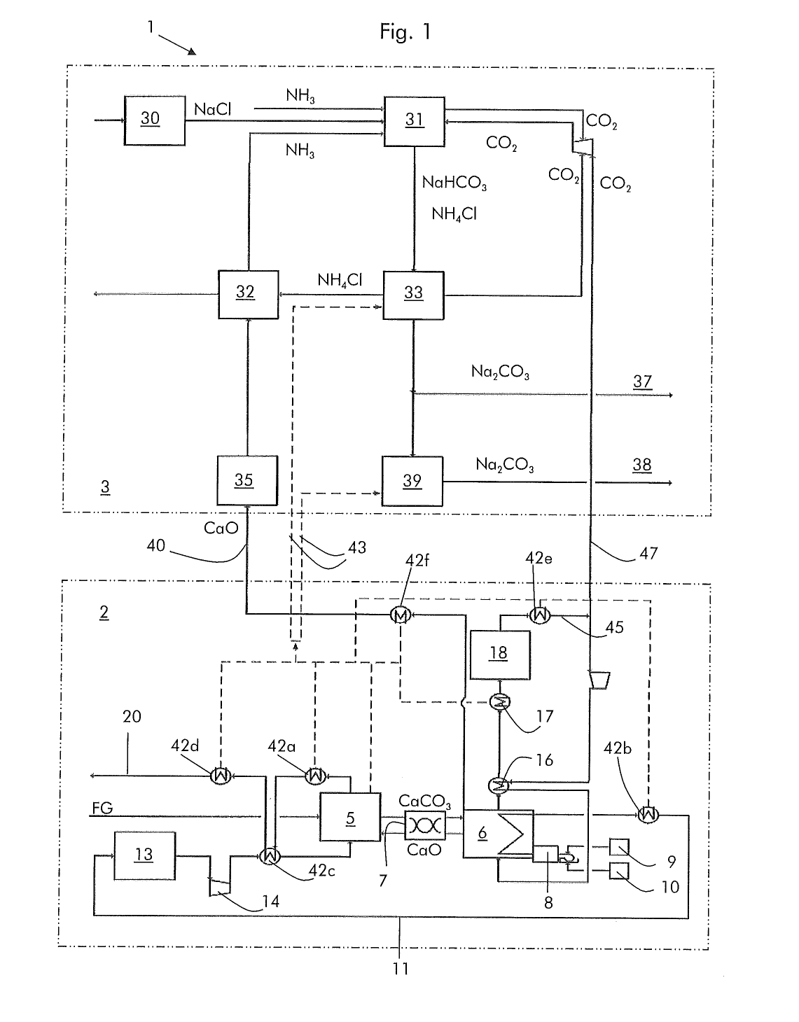

### DETAILED DESCRIPTION

With reference to the FIGURES, these show an arrangement 1 of a flue gas treatment system 2 by carbonation-calcination loop and soda ash production system 3 by Solvay process.

The flue gas treatment system comprises a carbonator 5 and a calciner 6.

The carbonator 5 receives flue gas FG from a combustion process and has carbon dioxide contained in the flue gas combined with a metal oxide such as CaO to generate a carbonated metal compound such as CaCO₃.

The reaction occurring at the carbonator is thus:

CO₂+CaO→CaCO₃.

This reaction occurs at a temperature of about 600-650° C.

The calciner 6 receives the carbonated metal compound CaCO₃ from the carbonator 5 and separates it by heat in carbon dioxide CO₂ and a metal oxide CaO.

The reaction occurring at the calciner 6 is thus:

CaCO₃→CO₂+CaO.

This reaction occurs at a temperature of about 900-1050° C.

In addition, the flue gas treatment system 2 includes a heat exchanger 7 for transferring heat of the CaO, moving from the calciner 6 to the carbonator 5, to the CaCO₃, moving from the carbonator 5 to the calciner 6.

The calciner 6 is provided with a burner 8 that combusts a fuel from a source 9 with air or oxygen from a source 10; the calciner 6 is preferably an indirect heated calciner, i.e. the combustion products from the burner 8 do not mix with the CO₂ and other gas and products contained in the calciner 6. This allows use of high quality fuels as well as low quality fuels.

The calciner shown in the FIGURE is an example of indirect heated calciner by means of indirect heat transfer via heat exchange surfaces. In other examples there can also be provided an indirect heated calciner by means of direct heat transfer via a heat transfer medium (e.g. a heat carrying inert solid). In addition, also direct calcination is possible, for example with oxygen firing (i.e. the fuel is combusted in presence of oxygen). The combustion products of the burner 8 are forwarded, via a line 11 and through a conditioning system 13 (such as a de-dusting unit and/or a desulphurization unit, etc.) and a fan 14, into the carbonator 5. The conditioning system 13 and fan 14 are anyhow not needed and can be used or not according to the needs.

The carbon dioxide CO₂ discharged from the calciner 6 is cooled in a first cooler 16 and then in a second cooler 17, it is then passed through a conditioning unit 18 and is recirculated back into the calciner 6.

The recirculated carbon dioxide CO₂ is used as the cooling medium for the carbon dioxide CO₂ released from the calciner 6 at the cooler 16; at the cooler 17 another fluid as the cooling medium for the carbon dioxide CO₂ is typically used, such as for example air or water or another thermo fluid from an external source.

The flue gas deprived of the carbon dioxide CO₂ is discharged from the carbonator 5 through a line 20.

The soda ash production system 3 comprises usually a reactor 30 for production of brine that can be used as the source of NaCl in the Solvay process; this reactor 30 is anyhow not mandatory and is used according to the design and needs.

The reactor 30 is connected to one or more first reactors 31 wherein the following reaction occurs:

NaCl+CO₂+NH₃+H₂O→NaHCO₃+NH₄Cl.

This reaction is often in practice carried out in a plurality of steps, each of which can be carried out in different reactors.

The first reactor 31 is connected to a second and a third reactors 32, 33.

NH₄Cl is transferred into the second reactor 32 for example via the third reactor 33, and NaHCO₃ is transferred into the third reactor 33.

At the second reactor 32 the following reaction occurs:

2NH₄Cl+CaO→2NH₃+CaCl₂+H₂O.

The CaO for this reaction is supplied from a slurry preparation step 35 that supplies lime milk into the second reactor 32. From the second reactor 32 NH₃ is forwarded into the first reactor 31.

At the third reactor 33 the following reaction occurs

2NaHCO₃→Na₂CO₃+H₂O+CO₂.

This reaction allows production of light soda ash 37 or dense soda ash 38 after a dense soda ash production step 39. It is clear that soda ash of any density can be produced and not only light and dense soda ash. For example also medium dense soda ash can be produced.

Advantageously, CaO and heat for use in the soda ash production system 3 are extracted from the flue gas treatment system 2.

In this respect, the arrangement 1 has a supply line 40 for CaO between the calciner 6 and the second reactor 32, via the slurry preparation step 35 that is for example implemented in a tank or reactor; the supply line 40 allows to supply CaO from the flue gas treatment system 2 to the soda ash production system 3.

In addition, the arrangement 1 also has one or more heat exchangers 42a-42f and one or more thermo fluid supply lines 43 between the heat exchangers 42a-f and at least the third reactor 33 and/or dense soda ash production step 39. The heat exchangers 42a-f and thermo fluid supply lines 43 allow to recover heat from the flue gas treatment system 2 and supply it to soda ash production system 3.

In addition, the heat available at one or more of the heat exchangers 42a-f can also be directly transferred to the third reactor 33 and/or dense soda ash production step 39; in this respect, for example at one or more of the heat exchangers 42a-f it is heated the process media used in the third reactor 33 and/or dense soda ash production step 39.

For example, one or more than one of the following solutions can be used:
a heat exchanger 42a can be connected to the flue gas discharge line 20 of the carbonator 5;
a heat exchanger 42b can be connected to the combustion products discharge line 11 of the calciner 6;
an auxiliary heat exchanger 42c can be connected between the combustion products discharge line 11 of the calciner 6 downstream of the conditioning system 13 and the flue gas discharge line 20 of the carbonator 5, for heating the flue gas discharged from the carbonator 5, and a heat exchanger 42d is further connected to the flue gas discharge line 20 of the carbonator 5 downstream the auxiliary heat exchanger 42c;
a heat exchanger 42e can be connected to a carbon dioxide discharge line 45 from the calciner 6;
a heat exchanger 42f can be connected to the supply line 40 for CaO.

In addition, further integration of the flue gas treatment system 2 and soda ash production system 3 can be envisaged.

For example, carbon dioxide CO₂ for use in the soda ash production system 3 can be extracted from the flue gas treatment system 2.

In this respect, the arrangement 1 can have a carbon dioxide supply branch 47 between the calciner 6 (for example it can be connected to the line 45 that is in turn connected to the calciner 6) and the first reactor 31.

The operation of the arrangement is apparent from what described and illustrated and is substantially the following.

The temperature at the carbonator 5 is between 600-650° C., the temperature at the calciner is between 900-1050° C., the temperature at the third reactor 33 and preferably also at the dense soda ash production step is between 150-250° C.

Flue gas FG is supplied into the carbonator 5 together with combustion products generated at the calciner 6.

At the carbonator, CO₂ contained in the flue gas and combustion products is combined with CaO forming CaCO₃.

Flue gas deprived from carbon dioxide CO₂ is released into the atmosphere via line 20; while passing through line 20 the flue gas is cooled in the heat exchanger 42a to transfer its heat to the thermo fluid; the flue gas is then heated in the auxiliary heat exchanger 42c by cooling the combustion products, to recover heat from the combustion products; the flue gas is then cooled again in the heat exchanger 42d to transfer its heat to the thermo fluid.

The thermo fluid is used to heat the third reactor 33 and/or the dense soda ash production step 39 and/or the other reactors and/or steps of the soda ash production system 3.

At the calciner 6 CaCO₃ is separated by heat into CaO and CO₂.

The CaO is partly supplied back into the carbonator 5 and partly is supplied to the second reactor 32, preferably but not necessarily via the slurry preparation step 35, for use in the soda ash production system 3.

Advantageously, since the CaO has a high temperature because it comes from the calciner 6, at the heat exchanger 42f the CaO is cooled to transfer its heat to a thermo fluid that is used to heat the third reactor 33 and/or the dense soda ash production step 39 and/or the other reactors and/or steps of the soda ash production system 3.

The combustion product generated at the calciner 6 are directed to the carbonator 5 via the line 11; these combustion products are cooled at the heat exchanger 42b to transfer their heat to a thermo fluid that is used to heat the third reactor 33 and/or the dense soda ash production step 39 and/or the other reactors and/or steps of the soda ash production system 3.

The carbon dioxide CO₂ from the calciner 6 passes through the heat exchanger 16, 17 and the conditioning unit 18 and it is then further cooled at the heat exchanger 42e.

At the heat exchanger 42e the carbon dioxide CO₂ is cooled to transfer its heat to a thermo fluid that is used to heat the third reactor 33 and/or the dense soda ash production step 39 and/or the other reactors and/or steps of the soda ash production system 3.

The heat exchanger 17 can be used to heat a thermo fluid to transfer heat to the soda ash production system 3 or alternatively it can use a cooling medium that is not used in the soda ash production system 3, for example in order to optimize carbon dioxide treatment at the conditioning unit 18 and efficiency of the calciner 6.

The carbon dioxide CO₂ from line 45 can be supplied partly to the first reactor 31 via the branch 47, partly back into the calciner 6, and partly can be captured or used in other ways.

Naturally the heat exchangers 42a-f (and the heat exchanger 17 when it is used to transmit heat from the flue gas treatment system 2 to the soda ash production system 3) can heat same or different reactors/steps of the soda ash production system 3. For example all heat exchangers could supply heat for both the third reactor 33 and the dense soda ash production step 39 at the same time, or some heat exchangers could provide heat for the third reactor 33 and others for the dense soda ash production step 39; combinations of these two solutions are also possible.

The present disclosure also refers to a method for flue gas treatment by carbonation-calcination loop and soda ash production by Solvay process. The method comprises extracting CaO and heat for use in the soda ash production from the flue gas treatment system.

In addition, carbon dioxide CO₂ for use in the soda ash production can be extracted from the carbonation-calcination loop.

Naturally the features described may be independently provided from one another.

In practice the materials used and the dimensions can be chosen at will according to requirements and to the state of the art.

1. An arrangement of a flue gas treatment system by carbonation-calcination loop and soda ash production system by Solvay process; the arrangement comprising CaO and heat for use in the soda ash production system are extracted from the flue gas treatment system.

2. The arrangement of claim 1, wherein the flue gas treatment system includes:
a carbonator for receiving flue gas from a combustion process and having carbon dioxide contained in the flue gas combined with CaO to generate CaCO₃,
a calciner for receiving CaCO₃ from the carbonator and separating it by heat in carbon dioxide and CaO, and
the soda ash production system comprises:
at least a first reactor for carrying out the reaction
NaCl+CO₂+NH₃+H₂O→NaHCO₃+NH₄Cl
at least a second reactor for carrying out the reaction
2NH₄Cl+CaO→2NH₃+CaCl₂+H₂O
at least a third reactor for carrying out the reaction
2NaHCO₃→Na₂CO₃+H₂O+CO₂.

3. The arrangement of claim 2, further comprising
a supply line for CaO between the calciner and the at least a second reactor, to supply the CaO from the flue gas treatment system to the soda ash production system, and
at least a heat exchanger to recover heat from the flue gas treatment system and supply it to soda ash production system.

4. The arrangement of claim 3, wherein the at least a heat exchanger is connected to a flue gas discharge line of the carbonator.

5. The arrangement of claim 2, wherein the calciner is an indirect heated calciner and has a burner with a combustion products discharge line connected to the carbonator.

6. The arrangement of claim 5, wherein the at least a heat exchanger is connected to the combustion products discharge line of the calciner.

7. The arrangement of claim 5, wherein the combustion products discharge line of the calciner has a flue gas conditioning system,
an auxiliary heat exchanger is connected between the flue gas discharge line of the calciner downstream of the conditioning system and a flue gas discharge line of the carbonator, for heating the flue gas discharged from the carbonator,
the heat exchanger is connected to the flue gas discharge line of the carbonator downstream the auxiliary heat exchanger.

8. The arrangement of claim 3, wherein the heat exchanger is connected to a carbon dioxide discharge line from the calciner.

9. The arrangement of claim 3, wherein the heat exchanger is connected to the supply line for CaO.

10. The arrangement of claim 1, wherein carbon dioxide for use in the soda ash production system is extracted from the flue gas treatment system.

11. The arrangement of claim 2, further comprising a carbon dioxide supply branch between the calciner and the first reactor.

12. The arrangement of claim 3, wherein the at least a thermo fluid supply line is also provided between the at least a heat exchanger and the dense soda ash production step.

13. The arrangement of claim 1, wherein the carbonator also receives combustion products from the calciner.

14. A method for flue gas treatment by carbonation-calcination loop and soda ash production by Solvay process; the method comprising extracting CaO and heat for use in the soda ash production from the flue gas treatment system.

15. The method of to claim 14, further comprising extracting carbon dioxide for use in the soda ash production from the carbonation-calcination loop.
